(19) United States
(12) Patent Application Publication
(10) Pub. No.: US 2023/0119415 A1
(43) Pub. Date: Apr. 20, 2023

(54) Self-Interference Correction

(71) Applicant: Nokia Technologies Oy, Espoo (FI)

(72) Inventors: Oana-Elena Barbu, Aalborg (DK); Benny VEJLGAARD, Gistrup (DK)

(21) Appl. No.: 17/914,460

(22) PCT Filed: Mar. 27, 2020
(86) PCT No.: PCT/EP2020/058754

§ 371 Date: Sep. 26, 2022

(51) Int. Cl. H04B 1/525

(52) U.S. Cl. CPC H04B 1/525

(57) ABSTRACT

An apparatus, method and computer program is described, including: obtaining a first received signal from a transmission system; obtaining or generating a first transmission signal for transmission using the transmission system; obtaining a plurality of input data, wherein the input data include transmission system data associated with the transmission system, environmental data and timestamp data; providing the first transmission signal and the plurality of input data as inputs to a self-interference correction algorithm to generate a self-interference estimate; and subtracting the self-interference estimate from the first received signal to generate a modified received signal.

### FIELD

The present specification relates to self-interference correction in communication systems.

### BACKGROUND

In communication systems (e.g. mobile communication systems) in which transmission and reception can occur at the same time, the transmit signal can leak into the receive signal chain. Depending on the circumstances, the power of the received signal may be significantly lower than the power of the transmit signal. Self-interference correction seeks to remove leakage transmit signals from the received signal (e.g. by subtraction). There remains a need for further developments in this field.

### SUMMARY

In a first aspect, this specification describes an apparatus comprising means for performing: obtaining a first received signal from a transmission system; obtaining or generating a first transmission signal for transmission using the transmission system; obtaining a plurality of input data, wherein the input data include transmission system data (such as bandwidth, carrier frequency sampling rate, precoder index and combiner index) associated with the transmission system, environmental data (such as temperature, humidity, pressure and altitude) and timestamp data; providing the first transmission signal and the plurality of input data as inputs to a self-interference correction algorithm to generate a self-interference estimate; and subtracting the self-interference estimate from the first received signal to generate a modified received signal (e.g. such that the modified received signal has no (or has reduced) self-interference noise).

Some example embodiments are further configured to perform: transmitting the first transmission signal for transmission using the transmission system.

Some example embodiments are further configured to use one or more extrinsic sensors to obtain at least some of said environmental data.

The plurality of input data may comprise antenna configuration data, wherein the antenna configuration data includes one or more of: antenna material, array shape, and array size. Alternatively, or in addition, the plurality of input data may comprise receiver feedback signals (such as ACLR data).

Some example embodiments are further configured to: trigger training of said self-interference correction algorithm, for example determining when training is required.

For example, an algorithm may toggle between training and deployment modes of operation. The said triggering may be based on timestamp data (periodic retraining), may be performance based or may be device-type dependent.

The said means may comprise: at least one processor; and at least one memory including computer program code, the at least one memory and the computer program configured, with the at least one processor, to cause the performance of the apparatus.

In a second aspect, this specification describes an apparatus comprising means for performing: obtaining (e.g. from a TX buffer) transmission signal samples for signals transmitted using a transmission system; obtaining receiver signal samples, wherein the receiver signal samples are based on self-interference transmission signals received from the transmission system in the absence of other transmitted data signals; obtaining a plurality of input data, wherein the input data include transmission system data (such as bandwidth, carrier frequency sampling rate, precoder index and combiner index) associated with the transmission system, environmental data (such as temperature, humidity, pressure and altitude) and timestamp data; and training a self-interference correction algorithm based on the transmission signal samples, the receiver signal samples and the plurality of input data, such that the self-interference correction algorithm generates self-interference estimates based on transmission signal samples and the input data, wherein the self-interference correction algorithm is a trainable algorithm (e.g. a neural network or some other machine-learning algorithm). The apparatus of the second aspect may be used for training a self-interference correction algorithm for use in the apparatus of the first aspect.

Some example embodiments are further configured to perform: generating said transmission signal samples and providing those transmission signal samples to a transmit signal buffer.

Some example embodiments are further configured to perform: generating the receiver signals samples based on the signals received from the transmission system and providing those receiver signal samples to a receiver signal buffer.

Some example embodiments are further configured to perform: transmitting the first transmission signal for transmission using the transmission system

Some example embodiments are further configured to use one or more extrinsic sensors to obtain at least some of said environmental data.

The plurality of input data may comprise antenna configuration data, wherein the antenna configuration data includes one or more of: antenna material, array shape, and array size. Alternatively, or in addition, the plurality of input data may comprise receiver feedback signals (such as ACLR data).

Some example embodiments are further configured to: trigger training of said self-interference correction algorithm. Thus, the apparatus may determine when training is required. For example, an algorithm may toggle between training and deployment modes of operation. The said triggering may be based on timestamp data (periodic retraining), may be performance based or may be device-type dependent.

The said means may comprise: at least one processor; and at least one memory including computer program code, the at least one memory and the computer program configured, with the at least one processor, to cause the performance of the apparatus.

In a third aspect, this specification describes an apparatus (e.g. a neural network or some other apparatus implementing a machine-learned algorithm) comprising means for performing: receiving an input vector at an input of a neural network, wherein the input vector comprising: a first transmission signal for transmission using the transmission system and a plurality of input data, wherein the input data include transmission system data associated with the transmission system, environmental data and timestamp data; and applying the input vector to the neural network to generate a self-interference estimate at an output of the neural network.

The said means may comprise: at least one processor; and at least one memory including computer program code, the at least one memory and the computer program configured, with the at least one processor, to cause the performance of the apparatus.

In a fourth aspect this specification describes a method comprising: obtaining a first received signal from a transmission system; obtaining or generating a first transmission signal for transmission using the transmission system; obtaining a plurality of input data, wherein the input data include transmission system data (such as bandwidth, carrier frequency sampling rate, precoder index and combiner index) associated with the transmission system, environmental data (such as temperature, humidity, pressure and altitude) and timestamp data; providing the first transmission signal and the plurality of input data as inputs to a self-interference correction algorithm to generate a self-interference estimate; and subtracting the self-interference estimate from the first received signal to generate a modified received signal (e.g. such that the modified received signal has no (or has reduced) self-interference noise).

Some example embodiments are further configured to transmit the first transmission signal for transmission using the transmission system.

The plurality of input data may comprise antenna configuration data, wherein the antenna configuration data includes one or more of: antenna material, array shape, and array size. Alternatively, or in addition, the plurality of input data may comprise receiver feedback signals (such as ACLR data).

Some example embodiments are further configured to: trigger training of said self-interference correction algorithm.

In a fifth aspect, this specification describes a method comprising: obtaining (e.g. from a TX buffer) transmission signal samples for signals transmitted using a transmission system; obtaining receiver signal samples, wherein the receiver signal samples are based on self-interference transmission signals received from the transmission system in the absence of other transmitted data signals; obtaining a plurality of input data, wherein the input data include transmission system data (such as bandwidth, carrier frequency sampling rate, precoder index and combiner index) associated with the transmission system, environmental data (such as temperature, humidity, pressure and altitude) and timestamp data; and training a self-interference correction algorithm based on the transmission signal samples, the receiver signal samples and the plurality of input data, such that the self-interference correction algorithm generates self-interference estimates based on transmission signal samples and the input data, wherein the self-interference correction algorithm is a trainable algorithm (e.g. a neural network or some other machine-learning algorithm). The method of the fifth aspect may be used for training a self-interference correction algorithm for use in the method of the fourth aspect.

Some example embodiments are further configured to generate said transmission signal samples and providing those transmission signal samples to a transmit signal buffer.

Some example embodiments are further configured to generate the receiver signals samples based on the signals received from the transmission system and providing those receiver signal samples to a receiver signal buffer.

Some example embodiments are further configured to transmit the first transmission signal for transmission using the transmission system

The plurality of input data may comprise antenna configuration data, wherein the antenna configuration data includes one or more of: antenna material, array shape, and array size. Alternatively, or in addition, the plurality of input data may comprise receiver feedback signals (such as ACLR data).

Some example embodiments are further configured to: trigger training of said self-interference correction algorithm.

In a sixth aspect, this specification describes a method comprising: receiving an input vector at an input of a neural network, wherein the input vector comprising: a first transmission signal for transmission using the transmission system and a plurality of input data, wherein the input data include transmission system data associated with the transmission system, environmental data and timestamp data; and applying the input vector to the neural network to generate a self-interference estimate at an output of the neural network.

In a seventh aspect, this specification describes an apparatus configured to perform any method as described with reference to the fourth, fifth or sixth aspects.

In an eighth aspect, this specification describes computer-readable instructions which, when executed by computing apparatus, cause the computing apparatus to perform any method as described with reference to the fourth, fifth or sixth aspects.

In a ninth aspect, this specification describes a computer program comprising instructions for causing an apparatus to perform at least the following: obtaining a first received signal from a transmission system; obtaining or generating a first transmission signal for transmission using the transmission system; obtaining a plurality of input data, wherein the input data include transmission system data (such as bandwidth, carrier frequency sampling rate, precoder index and combiner index) associated with the transmission system, environmental data (such as temperature, humidity, pressure and altitude) and timestamp data; providing the first transmission signal and the plurality of input data as inputs to a self-interference correction algorithm to generate a self-interference estimate; and subtracting the self-interference estimate from the first received signal to generate a modified received signal (e.g. such that the modified received signal has no (or has reduced) self-interference noise).

In a tenth aspect, this specification describes a computer program comprising instructions for causing an apparatus to perform at least the following: obtaining (e.g. from a TX buffer) transmission signal samples for signals transmitted using a transmission system; obtaining receiver signal samples, wherein the receiver signal samples are based on self-interference transmission signals received from the transmission system in the absence of other transmitted data signals; obtaining a plurality of input data, wherein the input data include transmission system data (such as bandwidth, carrier frequency sampling rate, precoder index and combiner index) associated with the transmission system, environmental data (such as temperature, humidity, pressure and altitude) and timestamp data; and training a self-interference correction algorithm based on the transmission signal samples, the receiver signal samples and the plurality of input data, such that the self-interference correction algorithm generates self-interference estimates based on transmission signal samples and the input data, wherein the self-interference correction algorithm is a trainable algorithm (e.g. a neural network or some other machine-learning algorithm).

In an eleventh aspect, this specification describes a computer program comprising instructions for causing an apparatus to perform at least the following: receiving an input vector at an input of a neural network, wherein the input vector comprising: a first transmission signal for transmission using the transmission system and a plurality of input data, wherein the input data include transmission system data associated with the transmission system, environmental data and timestamp data; and applying the input vector to the neural network to generate a self-interference estimate at an output of the neural network.

In a twelfth aspect, this specification describes a computer-readable medium (such as a non-transitory computer-readable medium) comprising program instructions stored thereon for performing (at least) the method of the fourth, fifth or sixth aspects.

In a thirteenth aspect, this specification describes an apparatus comprising: at least one processor; and at least one memory including computer program code which, when executed by the at least one processor, causes the apparatus to perform (at least) the method of the fourth, fifth or sixth aspects.

In a fourteenth aspect, this specification describes an apparatus comprising: means (such as an RX antenna module) for obtaining a first received signal from a transmission system; means (such as a control module) for obtaining or generating a first transmission signal for transmission using the transmission system; means (such as a first input module) for obtaining a plurality of input data, wherein the input data include transmission system data (such as bandwidth, carrier frequency sampling rate, precoder index and combiner index) associated with the transmission system, environmental data (such as temperature, humidity, pressure and altitude) and timestamp data; means (such as a self-interference correction module) for providing the first transmission signal and the plurality of input data as inputs to a self-interference correction algorithm to generate a self-interference estimate; and means (such as a subtractor) for subtracting the self-interference estimate from the first received signal to generate a modified received signal (e.g. such that the modified received signal has no (or has reduced) self-interference noise).

In a fifteenth aspect, this specification describes an apparatus comprising: means (such as a TX buffer) for obtaining transmission signal samples for signals transmitted using a transmission system; means (such as an RX buffer) for obtaining receiver signal samples, wherein the receiver signal samples are based on self-interference transmission signals received from the transmission system in the absence of other transmitted data signals; means for obtaining a plurality of input data, wherein the input data include transmission system data (such as bandwidth, carrier frequency sampling rate, precoder index and combiner index) associated with the transmission system, environmental data (such as temperature, humidity, pressure and altitude) and timestamp data; and means (such as a machine-learning training module) for training a self-interference correction algorithm based on the transmission signal samples, the receiver signal samples and the plurality of input data, such that the self-interference correction algorithm generates self-interference estimates based on transmission signal samples and the input data, wherein the self-interference correction algorithm is a trainable algorithm (e.g. a neural network or some other machine-learning algorithm).

In a sixteenth aspect, this specification describes an apparatus comprising: means (such as a first input module) for receiving an input vector at an input of a neural network, wherein the input vector comprises: a first transmission signal for transmission using the transmission system and a plurality of input data, wherein the input data include transmission system data associated with the transmission system, environmental data and timestamp data; and means (such as a self-interference cancellation module) for applying the input vector to the neural network to generate a self-interference estimate at an output of the neural network.

### BRIEF DESCRIPTION OF THE DRAWINGS

Example embodiments will now be described, by way of example only, with reference to the following schematic drawings, in which:

FIG. 1 is a block diagram of a system in accordance with an example embodiment;

FIG. 2 is a block diagram of a system in accordance with an example embodiment;

FIG. 3 is a flow chart showing an algorithm in accordance with an example embodiment;

FIG. 4 is a block diagram of a system in accordance with an example embodiment;

FIG. 5 is a block diagram of a system in accordance with an example embodiment;

FIG. 6 is a flow chart showing an algorithm in accordance with an example embodiment;

FIG. 7 is a block diagram of a neural network in accordance with an example embodiment;

FIG. 8 is a block diagram of a system in accordance with an example embodiment;

FIGS. 9 and 10 are flow charts showing algorithms in accordance with example embodiments;

FIGS. 11 to 14 are block diagrams of systems in accordance with example embodiments;

FIG. 15 is a flow chart showing an algorithm in accordance with an example embodiment;

FIG. 16 is a block diagram of components of a system in accordance with an example embodiment; and

FIGS. 17A and 17B show tangible media, respectively a removable non-volatile memory unit and a Compact Disc (CD) storing computer-readable code which when run by a computer perform operations according to example embodiments.

### DETAILED DESCRIPTION

The scope of protection sought for various embodiments of the invention is set out by the independent claims. The embodiments and features, if any, described in the specification that do not fall under the scope of the independent claims are to be interpreted as examples useful for understanding various embodiments of the invention.

In the description and drawings, like reference numerals refer to like elements throughout.

Self-interference arises in a scenario (e.g. full duplex (FD)) in which a transceiver, e.g. gNB or UE, transmits and receives signals simultaneously, in the same frequency, for example using different sets of antennas. In such a scenario, the transmit signal will tend to leak energy into the RF chain used to receive the useful signal, potentially contaminating the useful (receive) signal. Depending on the propagation conditions, the power of the received signal can be many orders of magnitude (e.g. in the order of hundreds) lower than that of the transmit signal. In this case, the leaked signal (which is generally referred to herein as a “self-interference signal”) may drown the received signal, making the decoding of the received signal difficult, or even impossible.

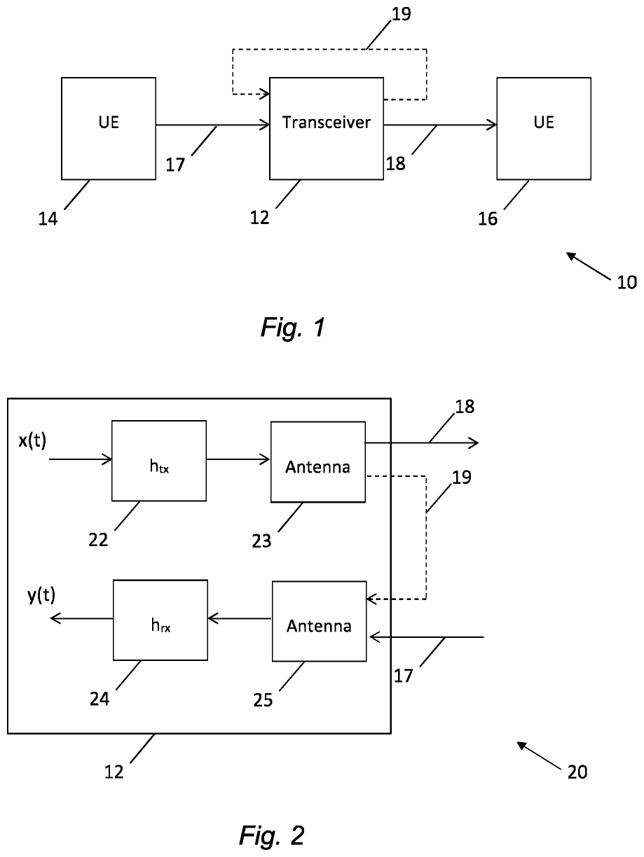

FIG. 1 is a block diagram of a system, indicated generally by the reference numeral 10, in accordance with an example embodiment.

The system 10 comprises a transceiver 12 (such as a base station or some other transmission node), a first user device 14 and a second user device 16. In the system 10, the first user device 14 is transmitting first signals (indicated by the arrow 17) to the transceiver 12 and the second user device 14 is receiving second signals (indicated by the arrow 18) from the transceiver 12. A self-interference (SI) signal indicated by the reference numeral 19 may act to drown out the signal 17 as received at the transceiver 12, as discussed above.

FIG. 2 is a block diagram of a system, indicated generally by the reference numeral 20, in accordance with an example embodiment.

The system 20 includes the transceiver 12 of the system 10 described above. As shown in FIG. 2, the transceiver 12 comprises a transmitter module 22, a first antenna 23, a receiver module 24 and a second antenna 25. The first antenna 23 outputs the second signals 18 discussed above and the second antenna 25 receives the first signals 17 discussed above.

The transmitter module 22 receives a signal for transmission x(t), applies a transfer function hₜₓ to that signal and transmits the signal xₐ(t)=x(t)*hₜₓ. A portion of that signal may be received at the second antenna 25, as indicated by the self-interference signal 19.

A signal yₐ (t) is received by the second antenna 25. That signal includes a first portion u(t) based on the first signal 17. In addition, the signal yₐ(t) includes the self-interference signal 19 as a result of the signal transmitted by the first antenna 23. The self-interference signal 19 received at the second antenna is based on the transmitted signal x(t), transmit chain non-linearities denoted by the response hₜₓ, antenna response and the propagation channel between the antennas 23 and 25 (denoted by h_{SI}) and receive chain non-linearities (denoted by hᵣₓ).

Thus, the signal received by the receiver chain of the transceiver 12 (i.e. the output of the receiver module 24) can be expressed as:

y(t)=((hₜₓ*h_{SI}*hᵣₓ)*x(t))+(u(t))

Where u(t) is the signal to be received and (hₜₓ*h_{SI}*hᵣₓ)*x(t) is the self-interference (SI) signal 19.

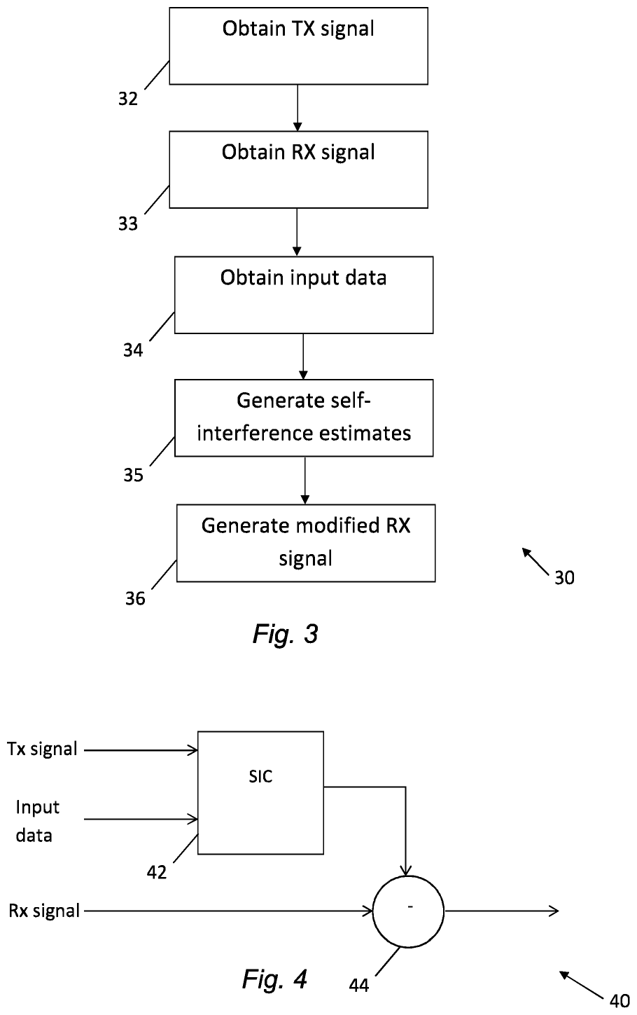

FIG. 3 is a flow chart showing an algorithm, indicated generally by the reference numeral 30, in accordance with an example embodiment.

The algorithm 30 starts at operation 32, where a first transmission signal for transmission using a transmission system (such as the transmission system 10) is obtained or generated.

At operation 33, a first received signal is obtained from the transmission system.

At operation 34, a plurality of input data is obtained, wherein the input data include transmission system data associated with the transmission system, environmental data and timestamp data (as discussed in detail below).

Clearly, the operations 32 to 34 could be performed in any order and two or more of the operations could be performed at the same time.

At operation 35, the first transmission signal (obtained in the operation 32) and the plurality of input data (obtained in the operation 34) are provided as inputs to a self-interference correction (SIC) algorithm to generate a self-interference estimate. The SIC algorithm may, for example, be a machine-learned SIC algorithm, as described in detail below.

At operation 36, the received signal obtained in operation 33 is modified by subtracting the self-interference estimated generated in operation 35 in order to generate a modified received signal. The modified received signal should have no (or reduced) self-interference noise as a result of the subtraction of the self-interference estimate.

FIG. 4 is a block diagram of a system, indicated generally by the reference numeral 40, in accordance with an example embodiment. The system 40 may be used in an example implementation of the algorithm 30 described above.

The system 40 comprises a self-interference correction (SIC) module 42 and a subtraction module 44. The SIC module 42 has a first input receiving a transmit signal (such as the signal obtained in the operation 32 described above) and a second input receiving input data (such as the plurality of input data obtained in the operation 34 described above). The SIC module 42 generates a self-interference correction (SIC) signal based on the transmission signal and the plurality of input data (thereby implementing the operation 35 of the algorithm 30).

The subtraction module 44 receives the received signal obtained in operation 33 and SIC signal generated by the SIC module 42. The subtraction module 44 generates a modified received signal by subtracting the SIC signal from the received signal, thereby implementing the operation 36 of the algorithm 30. The output of the subtraction module 44 is therefore the modified received signal which should contain no (or reduced) self-interference noise.

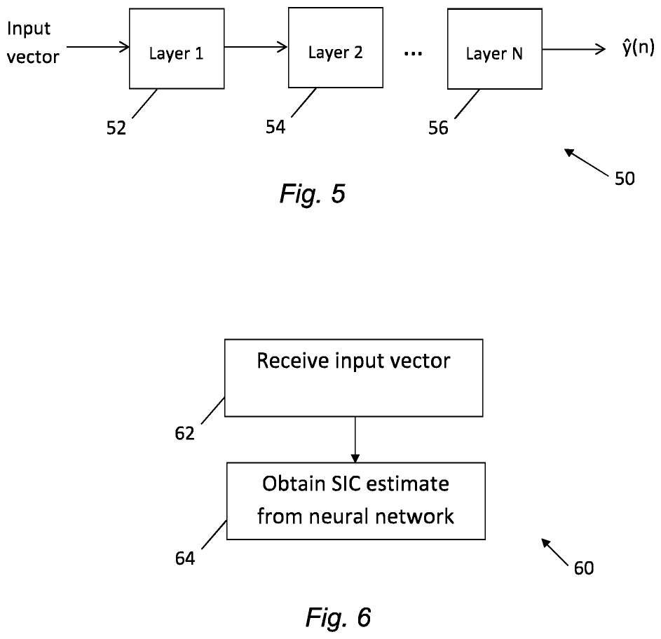

FIG. 5 is a block diagram of a system, indicated generally by the reference numeral 50, in accordance with an example embodiment. The system 50 is a neural network comprises a plurality of layers that may be used to implement the SIC module 42 described above. By way of example, FIG. 5 shows a first layer 52, a second layer 54 and an Nth layer 56.

An input vector is provided to the first layer 52, the output of the first layer is provided to the input of the second layer 54, the output of the second layer is provided to the input of a third layer (not shown) and so on, until the output of the N−1th layer is provided to the input of the Nth layer and the output of the Nth layer provides the output of the neural network 50.

The input vector provided to the first layer may comprises the inputs to the SIC module 42 described above (i.e. the transmit signal and the input data described above with reference to FIG. 4). The output of the neural network 50 (the signal ŷ(n)) is a self-interference estimate and may be used, for example, as the output of the SIC module 42.

FIG. 6 is a flow chart showing an algorithm, indicated generally by the reference numeral 60, in accordance with an example embodiment. The algorithm 60 may, for example, be implemented using the system 50 described above.

The algorithm 60 starts at operation 62, where an input vector is received at an input of a neural network, such as the neural network 50 described above (or the neural network 70 described below). The input vector may include: a first transmission signal for transmission using the transmission system and a plurality of input data, wherein the input data include transmission system data associated with the transmission system, environmental data and timestamp data.

At operation 64, a self-interference correction (SIC) estimate is obtained from the neural network in response to the applied input vector.

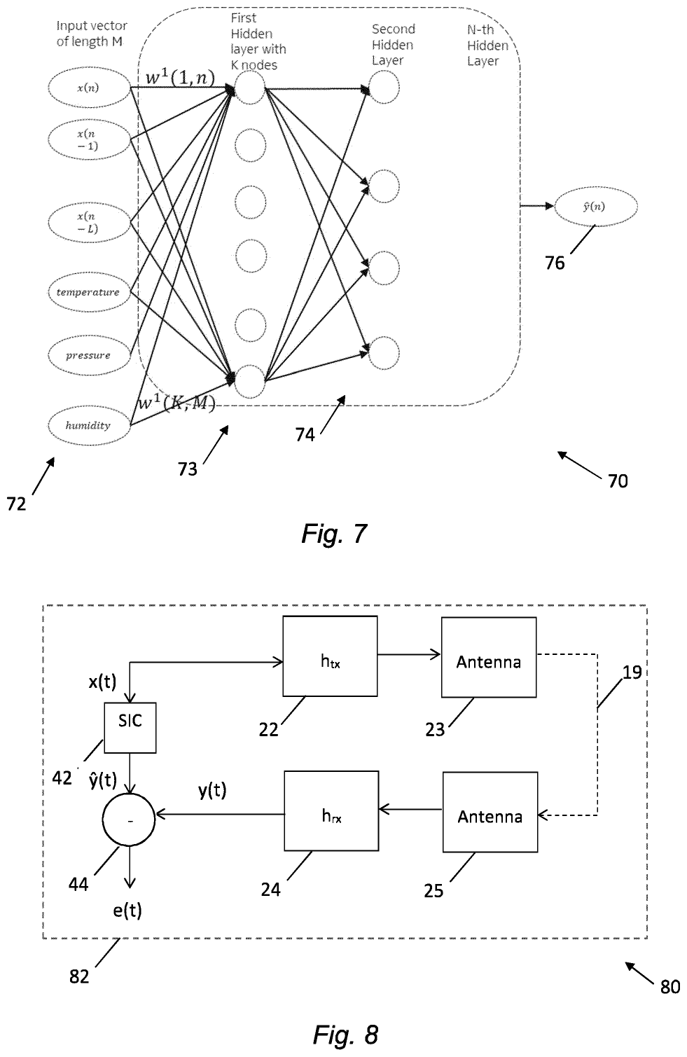

FIG. 7 is a block diagram of a neural network, indicated generally by the reference numeral 70, in accordance with an example embodiment. The neural network 70 may be used to implement the algorithm 60 and is an example implementation of the system 50 described above.

An input vector 72 (similar to the input vector 52 described above) is provided to the neural network 70. The example input vector 72 includes a number of transmission data samples and a plurality of other input data. In the example system 70, the transmission data samples comprise the samples x(n), x(n−1) and x(n−L) and the other data input comprise temperature, pressure and humidity.

Clearly, the input shows in FIG. 7 are provided by way of example only; other data inputs could be provided in addition to, or instead of, some of the data inputs shown. For example, the inputs described above are selected to fit the needs of a transceiver, such that different inputs may be chosen if, for example, the neural network 70 were implemented on a user device rather than a network node (such as a gNB or base station).

The neural network 70 has P hidden layers, each with Kₚ nodes, p=1: P (including at least a first hidden layer 73 and a second hidden layer 74).

A hidden layer p defines a selected mapping gₚ (also called activation function, e.g. linear, sigmoid, reLu, etc) so that the output of the final layer is:

ŷ(n)=g_{P}(g_{P-1}( . . . g₁(W⁽¹⁾v+b)))

Where the input vector can be:

v=[x(n), . . . ,x(n−L),temp,press,humid,antenna coupling,etc]

After the selection of the inputs and activation functions, the neural network 70 computes the weights W so that a chosen error metric (also called cost function) between the estimate y(n) and the value y(n) is minimized. Without loss of generality, the cost function C(y,ŷ) can be the mean squared error, cross entropy, Kullback-Leibler divergence, etc. Therefore, the optimization problem that NN-SIC solves reduces to finding the weights that fulfil:

Ŵ=arg min C(y,ŷ),

Where y=[y₁, . . . , y_{G}] is the measurement set of size G.

FIG. 8 is a block diagram of a system, indicated generally by the reference numeral 80, in accordance with an example embodiment.

The system 80 comprises a transceiver 82, that is similar to the transceiver 12 described above. In particular, the transceiver 82 comprises the transmitter module 22, the first antenna 23, the receiver module 24 and the second antenna 25 described above. The transceiver 82 further comprises the SIC module 42 and the subtraction module 44 of the system 40 described above.

The transmitter module 22 receives a signal for transmission x(t), applies a transfer function hₜₓ to that signal and transmits the signal xₐ(t)=x(t)*hₜₓ using the first antenna 23. A portion of the transmitted signal is received at the second antenna 25, as indicated schematically by the self-interference signal 19.

It should be noted that in the system 80, no signal is received at the second antenna 25 from the user device 14. Indeed, the signal received at the receive module 24 is based only on the self-interference signal 19.

The self-interference signal 19 received at the second antenna 25 is processed by the receiver module 24, which module outputs a received signal y(t).

The signal y(t) is based on the self-interference signal 19, antenna response and the propagation channel between the antennas 23 and 25 (denoted by h_{SI}) and receive chain non-linearities (denoted by hᵣₓ).

Thus, the signal output by the received module 24 can be expressed as:

y(t)=((hₜₓ*h_{SI}*hᵣₓ)*x(t))

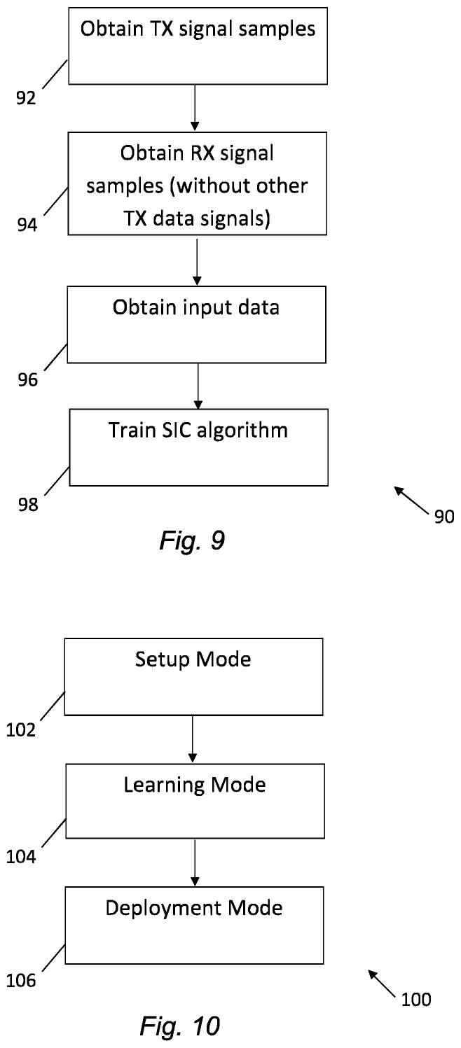

FIG. 9 is a flow chart showing an algorithm, indicated generally by the reference numeral 90, in accordance with an example embodiment.

The algorithm 90 starts at operation 92, where transmission signal samples are obtained for signals transmitted (or to be transmitted) using a transmission system, such as the system 80. For example, the transmission signals may be stored in a TX buffer, as described further below.

At operation 94, receiver signal samples are obtained, wherein the receiver signal samples are based on self-interference transmission signals received from the transmission system in the absence of other transmitted data signals (as described above with reference to the system 80). The receiver signal samples may be stored in a RX buffer, as described further below.

At operation 96, a plurality of input data may be obtained. The input data may include transmission system data associated with the transmission system, environmental data and timestamp data etc. Thus, the input data may take the form of the input vector described above.

At operation 98, a self-interference correction algorithm (for example, for use as the SIC module 42) may be trained, based on the transmission signal samples obtained in operation 92, the receiver signal samples obtained in operation 94 and the plurality of input data obtained in operation 96. The self-interference correction algorithm may then be used to generate self-interference estimates based on transmission signal samples and the input data.

The self-interference correction algorithm may be a trainable algorithm and may be implemented as a neural network or some other machine-learning algorithm, such as the neural network 70 described above.

The training of the neural network in the operation 98 may include the following steps:
Sample the observation set (v^{(k)}, y^{(k)}) at random and input them to the neural network/SIC being trained.
Propagate the inputs forward through the neural network/SIC and compute the estimated output ŷ^{(k)}.
Compute the cost function C.
Use back-propagation to obtain the gradients

$$\frac{δ C}{δ {W}_{p}}$$

with respect to each or me weights Wₚ.
Use gradient descent (or some similar algorithm) and the back-propagation of the previous step to update the weights Wₚ.
Repeat the steps above until the algorithm in complete (e.g. until convergence or until a maximum number of iterations have been completed).

Once the weights of neural network/SIC have been computed with the procedure above, the neural network/SIC has been trained and can be deployed.

It should be noted that, the algorithms described herein do not seek to model the effect H=(hₜₓ*h_{SI}*hᵣₓ) by approximating them with closed-form expressions such as FIR filters. Rather, the neural network/SIC seeks to compute a value y(n) that approximates well the real leakage y(n).

FIG. 10 is a flow chart showing an algorithm, indicated generally by the reference numeral 100, in accordance with an example embodiment.

The algorithm 100 starts at operation 102, where the algorithm 100 operates in a setup mode. When the setup mode 102 is completed, the algorithm 100 moves to operation 104, where the algorithm operates in a learning mode. When the learning mode 104 is complete, the algorithm boo moves to operation 106, where the algorithm operates in a deployment mode. Further details of the setup, learning and deployment modes are provided below.

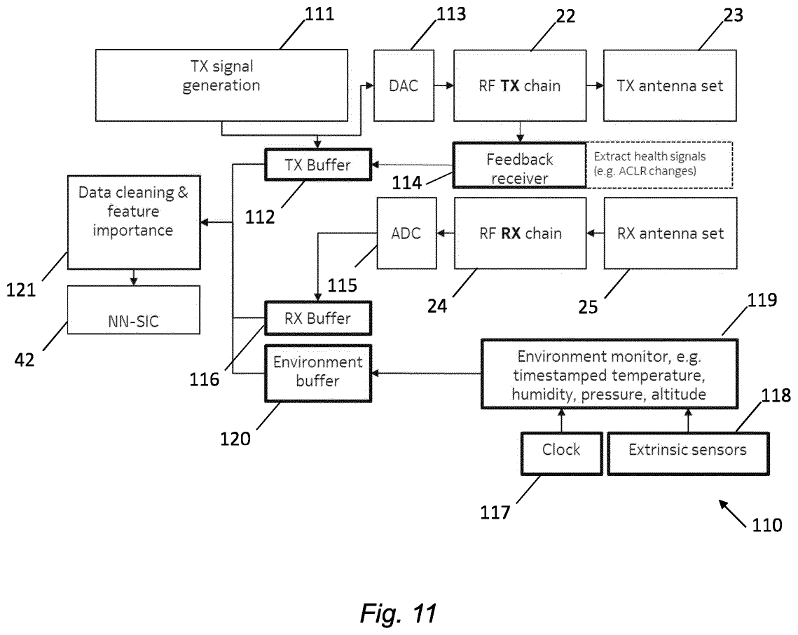

FIG. 11 is a block diagram of a system, indicated generally by the reference numeral 110, in accordance with an example embodiment.

The system no includes the transmitter module 22, the first antenna 23, the receiver module 24 and the second antenna 25 and the self-interference cancellation module 42 described above. The system no further comprises a TX signal generation module 111, a TX buffer 112, a digital-to-analogue (DAC) converter 113, feedback receiver module 114, an analogue-to-digital (ADC) converter 115, an RX buffer 116, a clock 117, a plurality of extrinsic sensors 118, an environment monitor 119, an environment buffer 120 and data cleaning module 121.

The TX signal generation module 111 generates transmission signal samples and provides those transmission signal samples to the transmit signal buffer 112 and to the DAC 113. The transmission signal samples may be the signal x(t) referred to above. The DAC 113 converts the transmission samples into analogue signals and provides those to the transmitter module 22 for transmission by the first antenna 23.

The transmitter module 22 may provide signals to the feedback receiver module 114, which module generates signals such as health signals, which are provided to the TX buffer 112.

The second antenna 25 obtains receiver signals, which are provided to the receiver module 24. The output of the receiver module is converted into a digital signal by the ADC 115 and stored in the RX buffer 115. The receiver signal samples output by the ADC 115 may be the signal y(t) referred to above.

The environment monitor 119 receives clock and sensor signals from the clock 117 and the extrinsic sensors 118. Environmental data is then stored in the environment buffer 120. By way of example, environmental data may include one or more of: temperature, humidity, pressure and altitude. At least some of the environmental data may be obtained from the extrinsic sensors, but other sources of environmental data are also possible.

The data cleaning module 121 receives data from the TX buffer 112, the RX buffer 116 and the environment buffer 120. Those data are prepare by the data cleaning module 121 and used to training the SIC module 42, as discussed further below.

In the system 110, if the feedback receiver module 114 sends an alarm to the TX buffer 112, then the TX buffer 112 may stop collecting TX samples until the feedback receiver signals a health state change. This may save memory and processing power, since the “data cleaning” module 121 would otherwise need to clean/discard a large amount of faulty signals.

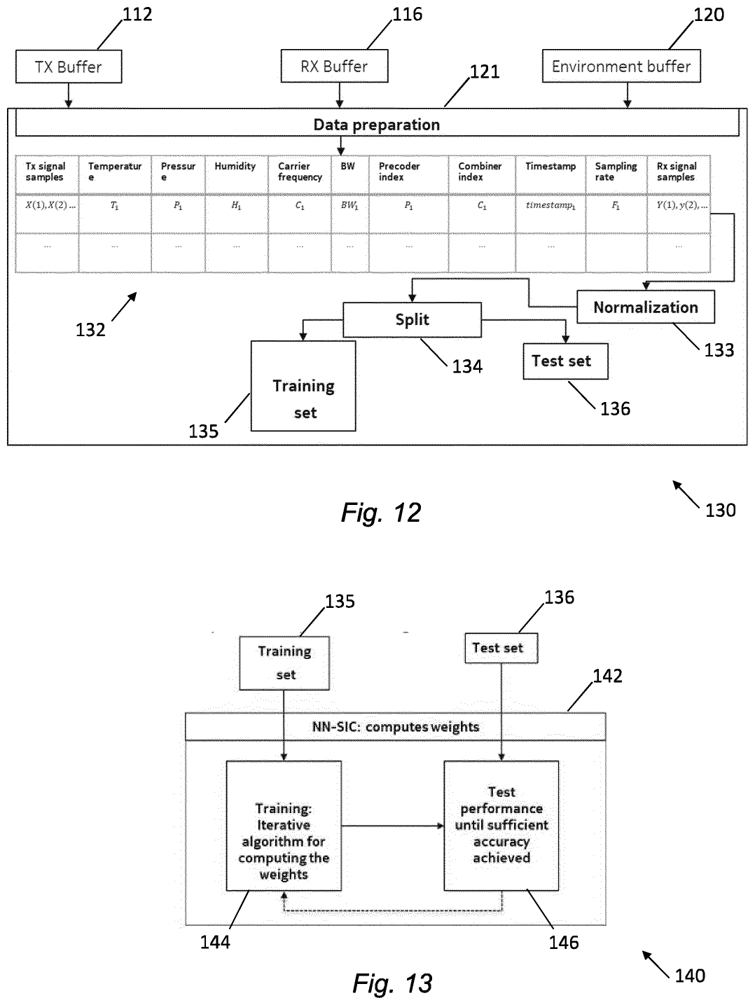

FIG. 12 is a block diagram of an example system, indicated generally by the reference numeral 130, in accordance with an example embodiment.

The system 130 includes the TX buffer 112, RX buffer 116 and environment buffer 120 described above. The data collected in those buffers is provided to the data preparation module 121 described above, where the data is prepared for use in training the SIC module 42. The system 130 also comprises a normalization module 133, a split module 134, a training set 135 and a test set 136.

Data preparation, as implemented by the data preparation module 121, includes two two steps: orthogonalization (e.g. feature importance) and normalization. Specifically, after collection, the input may be decorrelated (e.g. by PCA analysis) to speed up the neural network convergence.

The system 130 includes a table 132 that shows the data as prepared by the data preparation module 121. The table 132 includes TX signal samples (as collected by the TX buffer 112), RX signal samples (as collected by the RX buffer 116) and environment data (as collected by the environment buffer 120) and transmission system data. Other data that might be collected in the table 132 includes antenna configuration data (such as antenna material, array shape, array size etc.), received feedback signals (such as ACLR data), and timestamp data. Other data, not mentioned herein, could also be collected.

The specific table 132 shown in FIG. 12 includes the following data (by way of example):
TX signal samples;
Environment data comprising: temperature, pressure and humidity;
Transmission system data comprising: carrier frequency, bandwidth, precoder index, combiner index and sampling rate;
Timestamp data; and
RX signal samples.

The system 130 may collect data periodically over a period of time, in a variety of environment conditions. To that end, the transceiver 12 or 82 may be deployed in the field, or an accurate emulator of the field conditions may be used. For the SIC module to learn how aging hardware impacts the amount of leakage, each measurement may be timestamped.

The prepared data (e.g. the table 132) is proved to the normalisation module 133, which normalises the data (e.g. using min-max normalization). The split module 134 then splits the data into two sets (e.g. using random or pseudo-random splitting), with one set being the training set 135 (that is used for training) and the other being the test set 136 (that is used for testing (and potentially validation) of the performance of the trained SIC). Typical splits use 80% of the collected measurements for training and 20% for testing.

The system 130 can therefore be used to implement the setup mode 102 of the algorithm wo described above.

FIG. 13 is a block diagram of a system, indicated generally by the reference numeral 140, in accordance with an example embodiment. The system 140 can be used to implement the learning mode 104 of the algorithm 100 described above.

The system 140 comprises the training set of data 135, the test set of data 136 and a SIC training module 142. The SIC training module 142 comprises an iterative algorithm 144 for computing weights of a neural network implement a SIC module based on the training set of data 135. Thus, the weights W_{P} of the neural network 70 may be updated. The SIC training module 142 further comprises a testing module 146 for testing the trained SIC module based on the test set of data 136. The error between the expected output and the one computed by trained SIC module is evaluated. If the error is below a preselected threshold, then SIC module can be deployed (such that the operational mode 106 of the algorithm 100 may be entered). Otherwise, training may be repeated.

FIG. 14 is a block diagram of a system, indicated generally by the reference numeral 150, in accordance with an example embodiment. The system 150 (which is similar to the system no described above) may be used to implement the deployment mode 106 of the algorithm 100 described above.

The system 150 includes the TX signal generation module in, the DAC 113, the transmitter module 22, the first antenna 23, the receiver module 24, the second antenna 25, the self-interference cancellation module 42, the feedback receiver module 114, the ADC 115, the clock 117, the extrinsic sensors 118 and the environment monitor 119 of the system no described above. The system 150 further comprises the data preparation module 121, the subtractor module 44 and the RX signal 17 described above. The system 150 further comprise an inner receiver block 154 and an outer receiver block 155 (for channel estimation and decoding respectively).

In the deployment phase 106, the data preparation module 121 of the system 150 receives as inputs the instantaneous TX signal (from the TX signal generation module 111) and the time-stamped environmental data (from the environment monitor 119).

The data preparation module 121 process those data and passes them to the SIC module 42. The output of the SIC module 42 is provided to the subtractor module together with the output of the ADC 115 (that provides an instantaneous RX signal). The subtractor module 44 subtracts the SIC module output from the RX signal to generate a modified received signal.

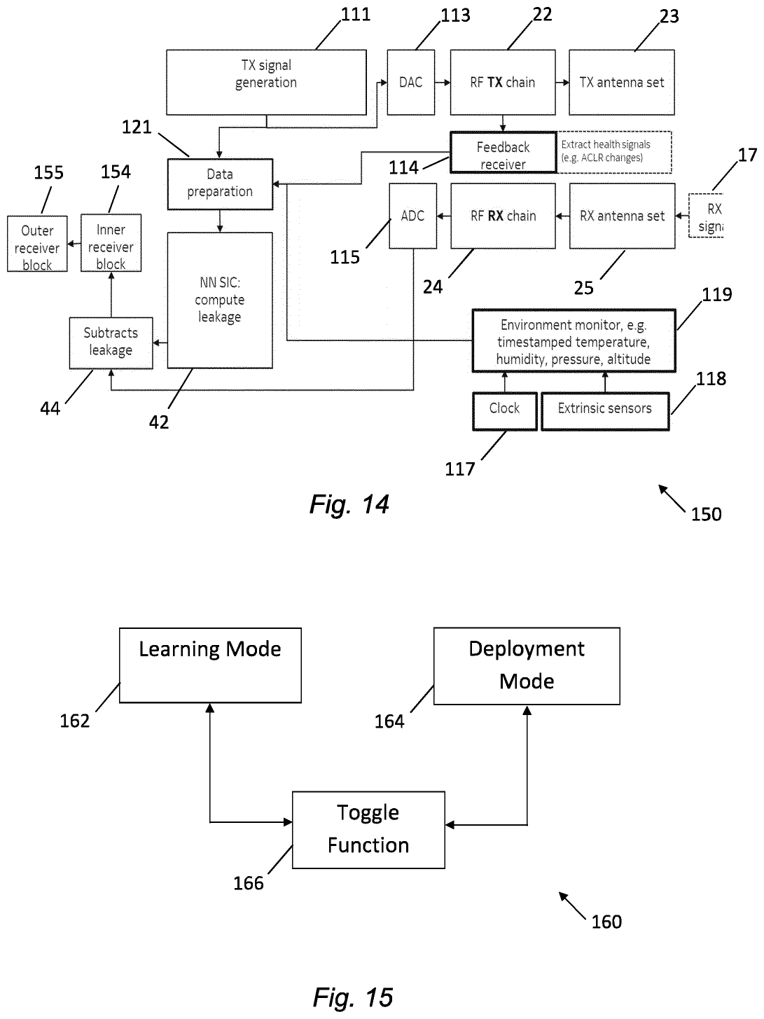

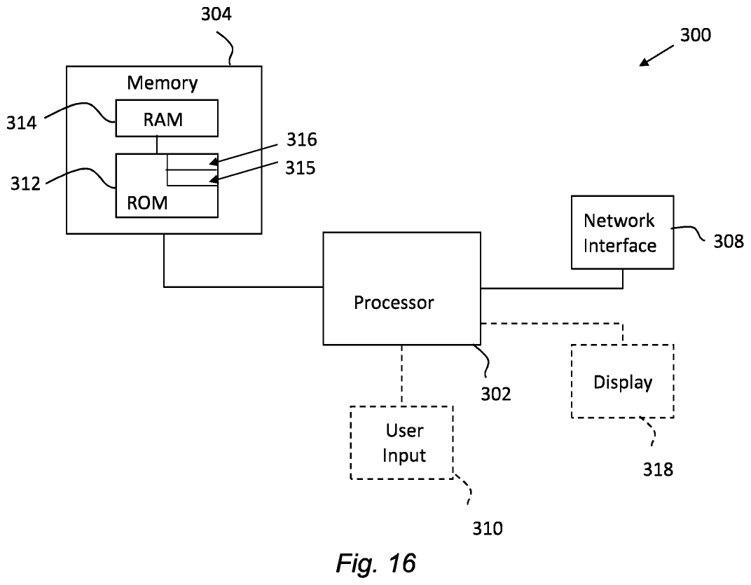

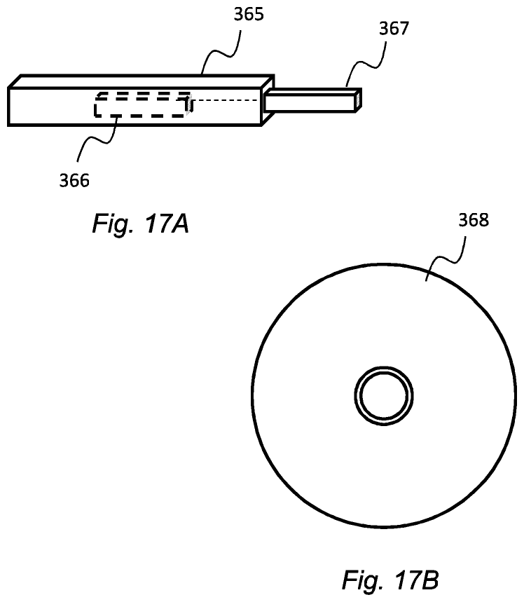

FIG. 15 is a flow chart showing an algorithm, indicated generally by the reference numeral 160, in accordance with an example embodiment.

The algorithm 160 includes a learning mode state 162, a deployment mode state 164 and a toggle function 166.

When the algorithm 160 is operating in the learning mode 162, the toggle function 166 is used to determine whether or not to transition into the deployment mode. When the algorithm 160 is operating in the deployment mode, the toggle function 166 is used to determine whether or not to transition into the learning mode (e.g. to trigger training of the SIC module 42 described above).

The toggle function 166 may be configured to retrain of the system over time to account for the hardware aging/degradation. For example, the TX buffer 112, the RX buffer 116 and the environment buffer 120 may be populated with new data, the SIC module 44 may be retained (in the learning mode 162) and the deployment mode 164 may then be re-entered. The benefit of this approach is that it can be triggered on a per-need basis, and does not require any hardware changes, but only NN-SIC software updates.

Similarly, the toggle function 166 may be configured to retrain the network to improve accuracy depending on the device type.

The toggle function 166 may be configured to trigger a change between operation modes and can be defined as: Toggle=f(t, n, a, d), where f is an indicator function, t=timestamp, n=number of measurements, a=SIC accuracy, d=radio type (e.g. o=UE, 1=gNB).

By way of example, the toggle function could be defined as with different thresholds depending on the radio type:

f(t,n,a,d)=1if(t≤T₀,n≤N₀,a≤A₀,d=0) 1 if(t≤T₁,n≤N₁,a≤A₁,d=1)

To train and test SIC module 44, field measurements may be collected. An exemplary methodology is outlined below:
A. Deploy the transceiver 12 or 82 in the field and start pilot data transmission.
B. Log the received signal (e.g. as follows):
   i. Record timestamp of the received signal. Discretize it by assigning labels, such as: morning (6.00−12.00)−0; (12.00−16.00)−1; (16.00−22.00)−2; (22.00−6.00);
   ii. Record antenna array material type and assign discrete label, e.g. Al−0; plasma−1; etc.
   iii. Record antenna array type and assign discrete label, e.g. x antenna elements−x;
   iv. Record transceiver age, e.g. y years;
   v. Record outdoor temperature, e.g. a.b degrees Celsius and discretize it by assigning labels, such as: (a.b<−10)−0; (−10<a.b<0)−1; (0<a.b<10)−2; a.b>10−3;
   vi. Record outdoor pressure;
   vii. Record humidity level;
   viii. Record altitude;
   ix. Buffer the received signal in the conditions 1-8.
C. Repeat steps A and B for z days/weeks.
D. Orthogonalize and normalize data from B, e.g. [0,1] normalization.
E. Feed x % of collected data to the SIC module 44 for training. Keep the rest of the collected data for testing/validation.
F. Use trained SIC module on the remaining (100-x) % data and compute mean square error. Compare it with selected threshold. If the performance is acceptable, stop. Else,
   i. Clean data.
   ii. Try other methods of normalizations.
   iii. Re-tune the parameters of the SIC module and re-train it.

For completeness, FIG. 15 is a schematic diagram of components of one or more of the example embodiments described previously, which hereafter are referred to generically as a processing system 300. The processing system 300 may, for example, be the apparatus referred to in the claims below.

The processing system 300 may have a processor 302, a memory 304 closely coupled to the processor and comprised of a RAM 314 and a ROM 312, and, optionally, a user input 310 and a display 318. The processing system 300 may comprise one or more network/apparatus interfaces 308 for connection to a network/apparatus, e.g. a modem which may be wired or wireless. The network/apparatus interface 308 may also operate as a connection to other apparatus such as device/apparatus which is not network side apparatus. Thus, direct connection between devices/apparatus without network participation is possible.

The processor 302 is connected to each of the other components in order to control operation thereof.

The memory 304 may comprise a non-volatile memory, such as a hard disk drive (HDD) or a solid state drive (SSD). The ROM 312 of the memory 304 stores, amongst other things, an operating system 315 and may store software applications 316. The RAM 314 of the memory 304 is used by the processor 302 for the temporary storage of data. The operating system 315 may contain code which, when executed by the processor implements aspects of the algorithms 30, 60, 90, 100 and 160 described above. Note that in the case of small device/apparatus the memory can be most suitable for small size usage i.e. not always a hard disk drive (HDD) or a solid state drive (SSD) is used.

The processor 302 may take any suitable form. For instance, it may be a microcontroller, a plurality of microcontrollers, a processor, or a plurality of processors.

The processing system 300 may be a standalone computer, a server, a console, or a network thereof. The processing system 300 and needed structural parts may be all inside device/apparatus such as IoT device/apparatus i.e. embedded to very small size.

In some example embodiments, the processing system 300 may also be associated with external software applications. These may be applications stored on a remote server device/apparatus and may run partly or exclusively on the remote server device/apparatus. These applications may be termed cloud-hosted applications. The processing system 300 may be in communication with the remote server device/apparatus in order to utilize the software application stored there.

FIGS. 14A and 14B show tangible media, respectively a removable memory unit 365 and a compact disc (CD) 368, storing computer-readable code which when run by a computer may perform methods according to example embodiments described above. The removable memory unit 365 may be a memory stick, e.g. a USB memory stick, having internal memory 366 storing the computer-readable code. The internal memory 366 may be accessed by a computer system via a connector 367. The CD 368 may be a CD-ROM or a DVD or similar. Other forms of tangible storage media may be used. Tangible media can be any device/apparatus capable of storing data/information which data/information can be exchanged between devices/apparatus/network.

Embodiments of the present invention may be implemented in software, hardware, application logic or a combination of software, hardware and application logic. The software, application logic and/or hardware may reside on memory, or any computer media. In an example embodiment, the application logic, software or an instruction set is maintained on any one of various conventional computer-readable media. In the context of this document, a “memory” or “computer-readable medium” may be any non-transitory media or means that can contain, store, communicate, propagate or transport the instructions for use by or in connection with an instruction execution system, apparatus, or device, such as a computer.

Reference to, where relevant, “computer-readable medium”, “computer program product”, “tangibly embodied computer program” etc., or a “processor” or “processing circuitry” etc. should be understood to encompass not only computers having differing architectures such as single/multi-processor architectures and sequencers/parallel architectures, but also specialised circuits such as field programmable gate arrays FPGA, application specify circuits ASIC, signal processing devices/apparatus and other devices/apparatus. References to computer program, instructions, code etc. should be understood to express software for a programmable processor firmware such as the programmable content of a hardware device/apparatus as instructions for a processor or configured or configuration settings for a fixed function device/apparatus, gate array, programmable logic device/apparatus, etc.

If desired, the different functions discussed herein may be performed in a different order and/or concurrently with each other. Furthermore, if desired, one or more of the above-described functions may be optional or may be combined. Similarly, it will also be appreciated that the flow diagrams of FIGS. 3, 6, 9, 10 and 15 are examples only and that various operations depicted therein may be omitted, reordered and/or combined.

It will be appreciated that the above described example embodiments are purely illustrative and are not limiting on the scope of the invention. Other variations and modifications will be apparent to persons skilled in the art upon reading the present specification.

Moreover, the disclosure of the present application should be understood to include any novel features or any novel combination of features either explicitly or implicitly disclosed herein or any generalization thereof and during the prosecution of the present application or of any application derived therefrom, new claims may be formulated to cover any such features and/or combination of such features.

Although various aspects of the invention are set out in the independent claims, other aspects of the invention comprise other combinations of features from the described example embodiments and/or the dependent claims with the features of the independent claims, and not solely the combinations explicitly set out in the claims.

It is also noted herein that while the above describes various examples, these descriptions should not be viewed in a limiting sense. Rather, there are several variations and modifications which may be made without departing from the scope of the present invention as defined in the appended claims.

1. An apparatus comprising:
at least one processor; and
at least one non-transitory memory including computer program code,
the at least one memory and the computer program code configured to, with the at least one processor, cause the apparatus to perform:
obtaining a first received signal from a transmission system;
obtaining or generating a first transmission signal for transmission using the transmission system;
obtaining a plurality of input data, wherein the input data include transmission system data associated with the transmission system, environmental data and timestamp data;
providing the first transmission signal and the plurality of input data as inputs to a self-interference correction algorithm to generate a self-interference estimate; and
subtracting the self-interference estimate from the first received signal to generate a modified received signal.

2. An apparatus comprising:
at least one processor; and
at least one non-transitory memory including computer program code,
the at least one memory and the computer program code configured to, with the at least one processor, cause the apparatus to perform:
obtaining transmission signal samples for signals transmitted using a transmission system;
obtaining receiver signal samples, wherein the receiver signal samples are based on self-interference transmission signals received from the transmission system in the absence of other transmitted data signals;
obtaining a plurality of input data, wherein the input data include transmission system data associated with the transmission system, environmental data and timestamp data; and
training a self-interference correction algorithm based on the transmission signal samples, the receiver signal samples and the plurality of input data, such that the self-interference correction algorithm generates self-interference estimates based on transmission signal samples and the input data, wherein the self-interference correction algorithm is a trainable algorithm.

3. An apparatus as claimed in claim 2, wherein the apparatus is further configured to perform: generating said transmission signal samples and providing those transmission signal samples to a transmit signal buffer.

4. An apparatus as claimed in claim 2, wherein the apparatus is further configured to perform: generating the receiver signals samples based on the signals received from the transmission system and providing those receiver signal samples to a receiver signal buffer.

5. An apparatus as claimed in claim 1, wherein the apparatus is further configured to perform: transmitting the first transmission signal for transmission using the transmission system.

6. An apparatus as claimed in claim 1, wherein the environmental data includes one or more of: temperature, humidity, pressure or altitude.

7. An apparatus as claimed in claim 1, wherein the apparatus is further configured to use one or more extrinsic sensors to obtain at least some of said environmental data.

8. An apparatus as claimed in claim 1, wherein the transmission system data includes one or more of: bandwidth, carrier frequency sampling rate, precoder index or combiner index.

9. An apparatus as claimed in claim 1, wherein the plurality of input data comprises antenna configuration data, wherein the antenna configuration data includes one or more of: antenna material, array shape, or array size.

10. An apparatus as claimed in claim 1, wherein the plurality of input data comprises receiver feedback signals.

11. An apparatus as claimed in claim 1, wherein the apparatus is further configured to: trigger training of said self-interference correction algorithm.

12. An apparatus comprising:
at least one processor; and
at least one non-transitory memory including computer program code,
the at least one memory and the computer program code configured to, with the at least one processor, cause the apparatus to perform:
receiving an input vector at an input of a neural network, wherein the input vector comprising: a first transmission signal for transmission using the transmission system and a plurality of input data, wherein the input data include transmission system data associated with the transmission system, environmental data and timestamp data; and
applying the input vector to the neural network to generate a self-interference estimate at an output of the neural network.

13. A method comprising:
obtaining a first received signal from a transmission system;
obtaining or generating a first transmission signal for transmission using the transmission system;
obtaining a plurality of input data, wherein the input data include transmission system data associated with the transmission system, environmental data and timestamp data;
providing the first transmission signal and the plurality of input data as inputs to a self-interference correction algorithm to generate a self-interference estimate; and
subtracting the self-interference estimate from the first received signal to generate a modified received signal.

14. A method comprising:
obtaining transmission signal samples for signals transmitted using a transmission system;
obtaining receiver signal samples, wherein the receiver signal samples are based on self-interference transmission signals received from the transmission system in the absence of other transmitted data signals;
obtaining a plurality of input data, wherein the input data include transmission system data associated with the transmission system, environmental data and timestamp data; and
training a self-interference correction algorithm based on the transmission signal samples, the receiver signal samples and the plurality of input data, such that the self-interference correction algorithm generates self-interference estimates based on transmission signal samples and the input data, wherein the self-interference correction algorithm is a trainable algorithm.

15. A non-transitory program storage device readable by an apparatus, tangibly embodying a computer program comprising instructions for causing the apparatus to perform at least the following:
obtaining a first received signal from a transmission system;
obtaining or generating a first transmission signal for transmission using the transmission system; obtaining a plurality of input data, wherein the input data include transmission system data associated with the transmission system, environmental data and timestamp data;
providing the first transmission signal and the plurality of input data as inputs to a self-interference correction algorithm to generate a self-interference estimate; and
subtracting the self-interference estimate from the first received signal to generate a modified received signal.
